(19) United States
(12) Patent Application Publication
(10) Pub. No.: US 2006/0169646 A1
(43) Pub. Date: Aug. 3, 2006

(54) Method and system for treating water

(75) Inventors: Stephan Andree, Wilmington, NC (US); Werner Krumpholz, Gunzburg (DE); Werner Probst, Gunzburg (DE); Wolfgang Kleiber, Ichenhausen (DE)

Correspondence Address: LOWRIE, LANDO & ANASTASI, RIVERFRONT OFFICE, ONE MAIN STREET, ELEVENTH FLOOR, CAMBRIDGE, MA, 02142, US

(73) Assignee: USFilter Corporation, Warrendale, PA (US)

(21) Appl. No.: 11/050,522

(22) Filed: Feb. 3, 2005

(51) Int. Cl. C02F 1/50

(52) U.S. Cl. 210/739; 210/746; 210/749

(57) ABSTRACT

Systems and techniques of treating water can be performed by utilizing characteristic functions to generate a control signal to regulate addition of a disinfecting species to the water. The characteristic functions, which can be a dynamic chlorine redox relationship between the oxidation-reduction potential and the concentration of free available chlorine species in the water, can be mapped, at least in part, by a corresponding sets of measured process parameters of the water. A triggering condition can initiate change and identification of the characteristic function.

### BACKGROUND OF INVENTION

1. Field of Invention

This invention relates to treating water and, in particular, to controlling addition of one or more disinfecting species based on a dynamic control relationship in water treatment systems.

2. Discussion of Related Art

Water treatment systems have been disclosed. For example, Martin in U.S. Pat. No. 6,620,315, discloses a system for optimized control of multiple oxidizer feedstreams. Martin, in U.S. Pat. No. 6,623,647, discloses methods of optimized control of multiple oxidizer feedstreams. Further, Martin, in U.S. Pat. No. 6,419,817, discloses the dynamic optimization of chemical additives in a water treatment system. In U.S. Pat. No. 6,409,926, Martin also discloses air and water purification using continuous breakpoint halogenation and peroxygenation systems and techniques. Various control systems and techniques have also been disclosed that may relate to aqueous systems. For example, Dennis, in U.S. Pat. No. 6,716,359, discloses enhanced time-based proportional control.

### SUMMARY OF THE INVENTION

In accordance with one or more embodiments, the invention relates to a method of facilitating water quality characterization. The method can comprise an act of providing a controller configured to receive a plurality of measurement signals from at least one oxidation-reduction potential (ORP) sensor and at least one free available chlorine sensor, to generate a first control signal based at least in part on a first dynamic chlorine redox relationship, and to generate a second control signal based at least in part on a second dynamic chlorine redox relationship.

In accordance with one or more embodiments, the invention relates to a method of facilitating water treatment. The method can comprise acts of mapping a first set of corresponding oxidation-reduction potential and free available chlorine values of the water to define a first control function, generating a first control signal based on the first control function, mapping a second set of corresponding oxidation-reduction potential and free available chlorine values of the water to define a second control function, and generating a second control signal based on the second control function.

In accordance with one or more embodiments, the invention relates to a method of treating water. The method can comprise acts of generating a first control signal according to a first control function, generating a second control signal according to a second control function, and regulating operation of a primary disinfecting system fluidly connected to the water based on the first control signal. The first control function can be mapped, at least in part, by a first set of measured process parameters of the water and the second control function can be mapped, at least in part, by a second set of measured process parameters.

In accordance with one or more embodiments, the invention relates to a computer-readable medium including computer-readable signals stored thereon defining instructions that, as a result of being executed by a computer, instruct the computer to perform a method of facilitating water treatment comprising acts of generating a first control signal according to a first control function and generating a second control signal according to a second control function. The first control function is mapped at least in part by a first set of measured process parameters of the water and the second control function is mapped at least in part by a second set of measured process parameters.

In accordance with one or more embodiments, the invention relates to a method of treating water. The method can comprise acts of measuring a first oxidation-reduction potential and a first concentration of free available chlorine species of the water, identifying a first control profile based at least in part on the first measured oxidation-reduction potential and the first measured free available chlorine species concentration, regulating addition of a source of free available chlorine species into the water based on the first control profile, measuring a second oxidation-reduction potential and a second concentration of free available chlorine species of the water, and identifying a second control profile based on at least one of the second measured oxidation-reduction potential and the second measured free available chlorine species concentration.

In accordance with one or more embodiments, the invention relates to a method of treating water. The method can comprise acts of measuring a first process parameter of the water, measuring a second process parameter of the water, generating a first control signal when the first process parameter and the second process parameter define a first characteristic relationship, and generating a second control signal when the first process parameter and the second process parameter define a second characteristic relationship.

In accordance with one or more embodiments, the invention relates to a system for treating water comprising an oxidation-reduction potential sensor disposed in the water and configured to generate an ORP signal corresponding to a measured oxidation-reduction potential of the water, a free available chlorine species sensor disposed in the water and configured to generate a FAC signal corresponding to a measured concentration of free available chlorine species in the water, a processor disposed to receive the ORP and FAC signals, and a storage medium in communication with the processor. The storage medium typically stores or is configured to store a first dynamic chlorine redox relationship and a second dynamic chlorine redox relationship. The first and second dynamic chlorine redox relationships can be defined, at least in part, by corresponding oxidation-reduction potential and free available chlorine species concentration values.

In accordance with one or more embodiments, the invention relates to a system for treating water comprising a first sensor disposed to measure a first process parameter of the water, wherein the first sensor is typically configured to provide a first measurement signal corresponding to the first process parameter; a second sensor disposed to measure a second process parameter of the water, wherein the second sensor is typically configured to provide a second measurement signal corresponding to the second process parameter; a controller configured to receive the first and second measurement signals and generate a first control signal and a second control signal, wherein the first control signal is typically based, at least in part, on a first control relationship between the first measured parameter and the second measured parameter and the second control signal is typically based, at least in part, on a second control relationship between the first measured parameter and the second measured parameter; and a primary disinfecting system disposed to receive the first control signal. The primary disinfecting system can be configured to introduce a disinfecting species or a precursor thereof to the water based on the first control signal.

In accordance with one or more embodiments, the invention relates to a method of treating water in an aquatic facility. The method can comprise acts of connecting a controller to a first process sensor disposed to provide a first process parameter of the water and to a second process sensor disposed to provide a second process parameter of the water and connecting the controller to a disinfecting system disposed to introduce at least one disinfecting species to the water. The controller is configured to execute an algorithm that generates a first control signal and a second control signal, the first control signal is based at least in part on a first characteristic function defined by a first set of process parameter values from the first and second process sensors and the second control signal is based at least in part on a second characteristic function defined by a second set of process parameter values from the first and second process sensors.

In accordance with one or more embodiments, the invention can provide a method of modifying an existing aquatic facility comprising configuring a controller to execute an algorithm that provides a first control signal based on a first characteristic function and a second control signal based on a second characteristic function, wherein the first characteristic function is defined by a first set of oxidation-reduction potential and free available chlorine concentration measurements of water in the aquatic facility and the second characteristic function is defined by a second set of oxidation-reduction potential and free available chlorine concentration measurements of the water.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates a treatment system in accordance with one or more embodiments of the invention;

FIG. 2 illustrates a computer system upon which one or more embodiments of the invention may be practiced;

FIG. 3 illustrates a storage system that may be used with the computer system of FIG. 3 in accordance with one or more embodiments of the invention;

FIG. 4 is a flow chart illustrating a process for the treatment of water or wastewater in accordance with one or more embodiments of the invention;

FIG. 5 is a graph illustrating characteristic relationships between oxidation-reduction potential and free available chlorine species in water;

FIG. 6 is a graph illustrating measured process parameters of a system in accordance with one or more embodiments of the invention during operation thereof;

FIG. 7 is graph illustrating output and determined values based on one or more of the measured parameters of illustrated in FIG. 6;

FIG. 8 is a graph illustrating measured process parameters of a system in accordance with one or more embodiments of the invention during operation thereof; and

FIG. 9 is graph illustrating output and determined values based on one or more of the measured parameters illustrated in FIG. 8.

### DEFINITIONS

As used herein, “plurality” means two or more. The terms “comprising,” “including,” “carrying,” “having,” “containing,” “involving,” whether in the written description or the claims and the like, are open-ended terms, i.e., to mean “including but not limited to.” Only the transitional phrases “consisting of” and “consisting essentially of,” are closed or semi-closed transitional phrases, respectively, with respect to the claims.

The phrase “characteristic relationship” refers to a behavior between a process parameter and one or more other process parameters of the water. Process parameters that may exemplarily constitute one or more characteristic relationships of the invention typically include measurable, inferable, and/or calculable quantities or values. Process parameters can also relate to or provide a measurable, inferable, and/or calculable values relating to the condition or quality of the fluid to be characterized and/or treated. Non-limiting examples of process parameters that may be utilized in one or more characteristic relationships in accordance with one or more systems and/or techniques of the invention include, but are not limited to, the temperature and/or pH of the water, collectively or at local or distinct sites or positions; the concentration of any one or more active species in the water; the concentration of any inactive species in the water; the concentration of one or more representative or proxy species that can provide or act as a surrogate indicator of one or more target species in the water or one or more properties of the water; and, in some cases, the oxidation-reduction potential of the water.

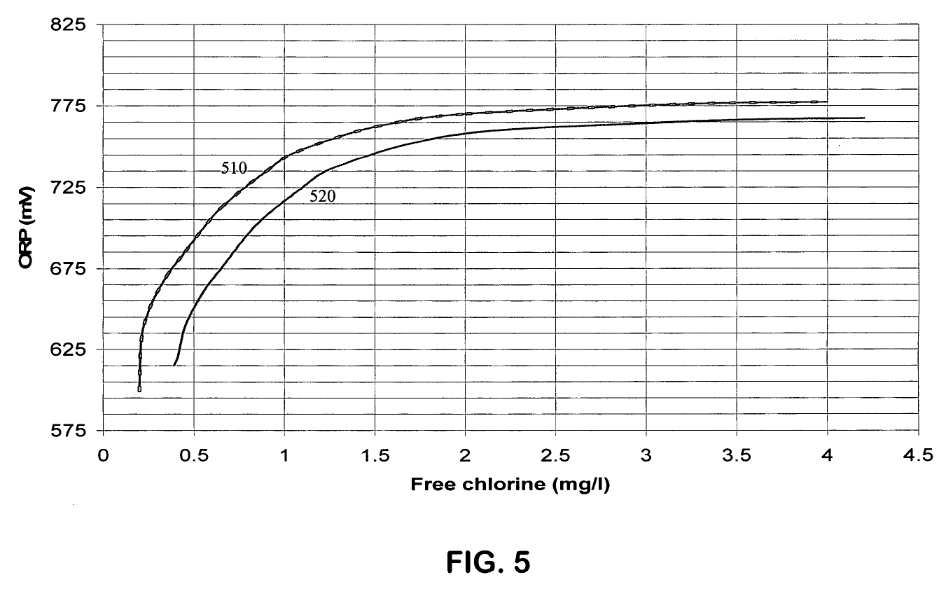

The phrase “dynamic chlorine redox relationship,” which is also represented as DCRR, pertains to a characteristic relationship between the oxidation-reduction potential and the concentration of free available chlorine species in the water. A particular fluid to be treated or undergoing treatment can have a set of oxidation-reduction potential values with corresponding free available chlorine species concentration values; the set of values define a characteristic relationship such that a particular free available chlorine species concentration will have a particular ORP for a particular DCRR. The DCRR of the fluid can vary and be influenced by several factors including, but not limited to, the pH of the fluid, the temperature of the fluid, the type and/or concentration of oxidizing and/or reducing species, and the type and/or concentration of oxidizable and/or reducible species in the fluid. Thus, as exemplarily shown in FIG. 5, a body of water can have a first DCRR that defines or is defined by a corresponding array or set of ORP and free available chlorine concentration values at a first condition and one or more other DCRRs that define or are defined by corresponding arrays or sets of ORP and free available chlorine concentration values at other conditions.

The phrases “control function” and “control relationship” refer to a relationship that can be utilized to define an operation that generates a value based on one or more parameters, which can be measured, inferred, and/or calculated. The control function can involve one or more operations or procedures, typically involving one or more instructions, which relate one or more parameters to an output product. For example, one or more process parameters can be operands in a control function that generates a product based on one or more characteristic relationships or characteristic functions. The resultant output product can be utilized in a control system and represent a control, output or driver signal.

A “control profile” is a particular control function that correlates one measured parameter to a second measurable parameter.

A “process parameter” is typically a measured or calculated quantity. Examples of process parameters include, but are not limited to, pH, temperature, pressure, oxidation-reduction potential, concentration, flow rate, turbidity, viscosity, mass, volume, and saturation index. Process parameters can also be intrinsic quantities such as, but not limited to, expansion coefficient, enthalpy, boiling point, freezing point, density, thermal conductivity, and heat capacity.

A “triggering condition” or “trigger” refers to one or more requirements, prerequisites, or restrictions that must be satisfied before a change can be initiated or accepted. For example, a “threshold requirement” or “threshold parameter” can invoke a triggering condition by requiring a parameter, which can be a measured, inferred, and/or calculated quantity, to meet or exceed a predetermined value. The latter can be a predetermined or preset constant but can also vary with respect to the triggering condition.

A “disinfecting species” serves to decontaminate, sanitize, render inactive or inert, or at least reduce the activity, typically biological activity, of one or more target species in a fluid to be treated. Disinfecting species include, but are not limited to oxidizing species or compounds as well as precursors thereof, such as, for example, halogen and peroxygen compounds as well as ozone. Target species can include, for example, microorganisms as well as organic compounds. Thus, a disinfecting species can destroy microorganisms and/or oxidize organic species.

### DETAILED DESCRIPTION

This invention is not limited in its application to the details of construction and the arrangement of components set forth in the following description or illustrated in the drawings. The invention is capable of embodiments and of being practiced or of being carried out in various ways beyond those exemplarily presented herein.

In accordance with one or more embodiments, the invention relates to one or more systems, methods, or techniques of facilitating water quality characterization that can perform or comprise one or more acts of providing a controller configured to receive a plurality of measurement signals from at least one oxidation-reduction potential sensor and at least one free available chlorine sensor, to generate a first control signal based, at least in part, on a first dynamic chlorine redox relationship, and to generate a second control signal based, at least in part, on a second dynamic chlorine redox relationship. The invention can also relate to systems and techniques that can perform or comprise one or more acts of mapping a first set of corresponding oxidation-reduction potential and free available chlorine values of the water to define a first control function, generating a first control signal based on the first control function, mapping a second set of corresponding oxidation-reduction potential and free available chlorine values of the water to define a second control function, and generating a second control signal based on the second control function.

In accordance with further embodiments, the invention relates to systems and techniques of treating water which can perform or comprise one or more acts of generating a first control signal according to a control function, such as a first control function, generating a second control signal according to a second control function, and regulating operation of a primary disinfecting system fluidly connected to the water and typically based on the first control signal. The first control function can be mapped, at least in part, by a first set of measured process parameters of the water and the second control function can be mapped, at least in part, by a second set of measured process parameters. Treating the water can further comprise one or more acts of identifying a triggering condition before performing the act of generating the second control signal. For example, the act of generating the second control signal can be performed if a threshold requirement is satisfied.

The first set of measured process parameters can comprise a first array of corresponding measured oxidation-reduction potential values and free available chlorine species concentration values of the water. The second set of measured process parameters can comprise a second array of corresponding measured oxidation-reduction potential values and free available chlorine species concentration values of the water. In some cases, the second array of corresponding measured oxidation-reduction potential values and free available chlorine species concentration values can be measured after a predetermined time following the measurement of the first array of corresponding measured oxidation-reduction potential values and free available chlorine species concentration values. The second control signal can be utilized to regulate the operation of a secondary disinfecting system fluidly connected to the water. For example, the secondary disinfecting system can comprise an actinic radiation apparatus and be regulated thereby through the second control signal. Other systems and techniques suitable as secondary and, in some cases primary, disinfecting system include those that deliver or utilize ozone and/or peroxygen compounds.

The invention can be further relate to computer-readable media including computer-readable signals stored thereon defining instructions that, as a result of being executed by a computer, instruct the computer to perform a method of facilitating water treatment comprising acts of generating a first control signal according to a first control function and generating a second control signal according to a second control function. The first control function is mapped, at least in part, by a first set of measured process parameters of the water and the second control function is mapped, at least in part, by a second set of measured process parameters. In some cases, one or more characteristic relationships pertinent to an aquatic system can be stored in the computer-readable media.

The systems and techniques of the invention can perform and/or comprise one or more acts of measuring a first oxidation-reduction potential and a first concentration of free available chlorine species of the water, identifying a first control profile based at least in part on the first measured oxidation-reduction potential and the first measured free available chlorine species concentration, regulating addition of a source of free available chlorine species into the water based on the first control profile, measuring a second oxidation-reduction potential and a second concentration of free available chlorine species of the water, and identifying a second control profile based on at least one of the second measured oxidation-reduction potential and the second measured free available chlorine species concentration. The first control profile can define a first dynamic chlorine redox relationship and the second control profile can define a second dynamic chlorine redox relationship. Optionally, the method can further comprise one or more acts that can generate a control signal based on the second control profile. In other cases, one or more further acts of the various techniques of the invention can involve regulating activity of one or more actinic radiation sources based on, for example, the second control signal. In accordance with further embodiments of the invention, treating the water can comprise one or more acts pertaining to regulating the addition of an oxidizing compound, or one or more precursors thereof, based on the second control signal.

In accordance with still further embodiments, the systems and techniques of the invention can further comprise one or more acts of regulating a pH of the water to within a predetermined pH range, and/or regulating a temperature of the aquatic system to achieve a target temperature or temperature range.

The systems and techniques of the invention can further comprise one or more acts directed to calculating one or more expected oxidation-reduction potential values, typically based on one or more particular control profiles, such as the first control profile. In accordance with yet further embodiments, one or more systems and techniques of the invention can involve one or more acts directed to determining a difference between the expected oxidation-reduction potential value and the second measured oxidation-reduction potential value. Further, one or more acts can be performed involving comparing the difference between the expected oxidation-reduction potential and the second measured oxidation-reduction potential to a threshold parameter, which, for example, can be about 10 mV. In accordance with still other embodiments, the invention can comprise one or more acts directed to identifying the second control profile if the difference between the expected oxidation-reduction potential and the second measured oxidation-reduction potential is greater than the threshold parameter, which, for example, can be in a range from about 3 mV to about 50 mV.

Treating the water can also comprise one or more acts of measuring a first process parameter of the water, measuring a second process parameter of the water, generating a first control signal when the first process parameter and the second process parameter define a first characteristic relationship, and generating a second control signal when the first process parameter and the second process parameter define a second characteristic relationship. The first process parameter can be an oxidation-reduction potential of the water and the second process parameter can be a concentration of free available chlorine species in the water. The first control signal can be directed to effect the regulation of introduction of one or more disinfecting species, or a precursor thereof, into the water. For example, the second control signal can activate one or more secondary disinfecting systems typically disposed to be or in fluid communication with the water.

In some cases, one or more systems of the invention can comprise at least one oxidation-reduction potential sensor disposed in the water and configured to generate an ORP signal corresponding to a measured oxidation-reduction potential of the water, at least one free available chlorine species sensor disposed in the water and configured to generate a FAC signal corresponding to a measured concentration of free available chlorine species in the water, at least one processor disposed to receive the ORP and FAC signals, and at least one storage medium in communication with the at least one processor. The at least one storage medium typically stores or is configured to store a first dynamic chlorine redox relationship and a second dynamic chlorine redox relationship. The first and second dynamic chlorine redox relationships can be defined, at least in part, by corresponding oxidation-reduction potential and free available chlorine species concentration values. The processor can be configured to generate a first control signal, which can be based on the first dynamic chlorine redox relationship, and a second control signal, which can be based on the second dynamic chlorine redox relationship. The system can further comprise one or more pH sensors disposed to measure and provide water pH values.

Any suitable sensor can be utilized to measure any one or more process parameters of the system. For example, any one or more of colorimetric, amperometric, and/or potentiometric based devices can be used to measure any one of pH, free available chlorine concentration, and oxidation-reduction potential. Moreover, analytical devices and techniques can be utilized to provide any one or more of the measured parameters, alone or in combination with one or more separate sensors.

One or more systems of the invention can comprise a first sensor disposed to measure a first process parameter of the water. The first sensor is typically configured to provide a first measurement signal corresponding to the first process parameter. The system can further comprise a second sensor disposed to measure a second process parameter of the water. The second sensor is typically configured to provide a second measurement signal corresponding to the second process parameter. The system can further comprise one or more controllers configured to receive at least the first and second measurement signals and generate a first control signal and a second control signal. The controller can be configured such that the first control signal is typically based, at least in part, on a first control relationship between the first measured parameter and the second measured parameter. The controller can be further configured such that the second control signal is typically based, at least in part, on a second control relationship between the first measured parameter and the second measured parameter. The system can further comprise one or more disinfecting systems or subsystems such as, but not limited to, a primary disinfecting system which can be, for example, disposed to receive the first control signal and introduce one or more disinfecting species, or one or more precursors thereof, to the water, typically based on the first control signal. In some cases, one of the first and second control signals can be further based on a pH value of the water.

One or more systems of the invention can further comprise a secondary disinfecting system. Such secondary or alternate disinfecting subsystems can comprise, for example, an actinic radiation source. The secondary disinfecting system can thus be configured to irradiate at least a portion of the water based on the second control signal and promote at least one reaction that facilitates disinfection. For example, a side-stream can be diverted from a bulk water body to a secondary disinfecting system configured to irradiate the side-stream with actinic radiation, and thereafter, be returned to the bulk water body. The secondary disinfecting system can also comprise a source of a second disinfecting species, or one or more precursors thereof. The system controller can be further configured to generate a third control signal that can be based, at least in part, on a third control relationship between the measured parameters.

Advantageously, a process algorithm that can continuously or intermittently verify whether the chlorine redox relationship factor or relationship needs to be changed can be utilized to compensate for a changing load in an aquatic system. Thus, in accordance with one or more embodiments of the invention, an algorithm can be utilized to determine a chlorine redox relationship factor when the process parameter measurement differs from a calculated parameter value by a modifiable amount. Because the algorithm can perform such a determination, which can be performed on an adjustable schedule related to the treatment of water, it can be used to start and/or stop the operation of one or more secondary disinfection systems, such as ultraviolet radiation-based actinic systems.

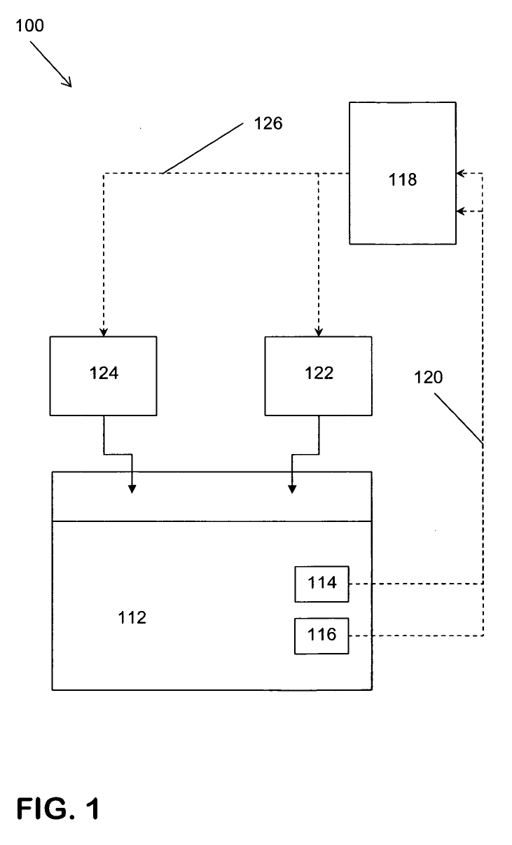

As exemplarily shown in FIG. 1, one or more embodiments of the invention can be directed to a treatment system 100 containing fluid to be treated, such as water 112. System 100 typically further includes one or more sensors 114 and 116 which are disposed to measure, monitor or provide an indication of one or more process parameters of water 112. In accordance with one or more embodiments of the invention, sensors 114 and/or 116 can provide an indication of a quality or condition of the fluid to be treated. Sensors 114 and 116 are typically connected to one or more controllers or control systems 118, which typically include one or more computers or computer systems, such that sensors 114 and/or 116 can provide one or more measured or measurement signals 120 to controller 118. System 100 can further include one or more disinfecting systems such as subsystems 122 and 124, which can be, for example, a primary disinfecting system 122 and a secondary disinfecting system 124 and/or a pH control system. Controller 118 typically provides or transmits one or more output signals 126 to the one or more subsystems 122 and 124 to regulate activity thereof, typically through actuation of one or more components such as valves and/or pumps therein. For example, output signal 126 can be a pneumatic signal that can actuate valves in one or both subsystems 122 and 124. In some cases, signal 126 can direct the magnitude or intensity of a delivered dose of energy or active species to water 112. Signals 120 and 126 can be communicated by any conventional techniques including those utilizing wired and/or wireless protocols.

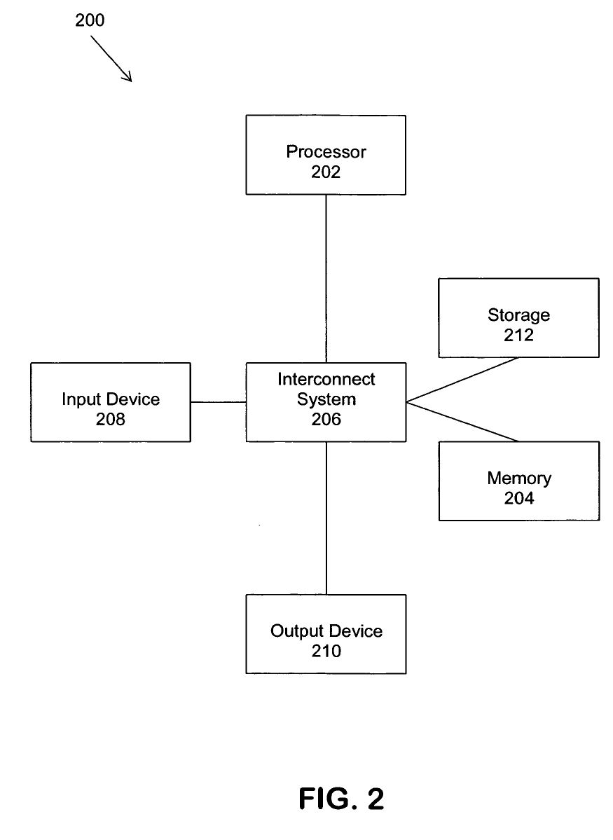

Controller 118 may be implemented using one or more computer systems 200 as exemplarily shown in FIG. 2. Computer system 200 may be, for example, a general-purpose computer such as those based on an Intel PENTIUM®-type processor, a Motorola PowerPC® processor, a Sun UltraSPARC® processor, a Hewlett-Packard PA-RISC® processor, or any other type of processor or combinations thereof. Alternatively, the computer system may include specially-programmed, special-purpose hardware, for example, an application-specific integrated circuit (ASIC) or controllers intended for water treatment system including, but not limited to those commercially available such as the STRANTROL® MG/L 5 controller from USFilter Corporation, Stranco Products, Bradley, Ill.

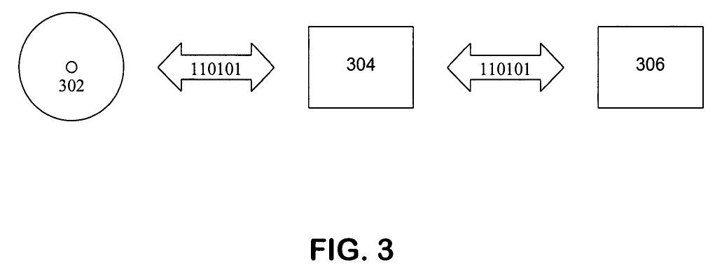

Computer system 200 can include one or more processors 202 typically connected to one or more memory devices 204, which can comprise, for example, any one or more of a disk drive memory, a flash memory device, a RAM memory device, or other device for storing data. Memory 204 is typically used for storing programs and data during operation of the system 100 and/or computer system 200. For example, memory 204 may be used for storing historical data relating to the parameters of the water over a period of time, as well as current sensor measurement data. Software, including programming code that implements embodiments of the invention, can be stored on a computer readable and/or writeable nonvolatile recording medium (discussed further with respect to FIG. 3), and then typically copied into memory 204 wherein it can then be executed by processor 202. Such programming code may be written in any of a plurality of programming languages, for example, Java, Visual Basic, C, C#, or C++, Fortran, Pascal, Eiffel, Basic, COBAL, or any of a variety of combinations thereof.

Components of computer system 200 may be coupled by an interconnection mechanism 206, which may include one or more busses (e.g., between components that are integrated within a same device) and/or a network (e.g., between components that reside on separate discrete devices). The interconnection mechanism typically enables communications (e.g., data, instructions) to be exchanged between components of system 200.

Computer system 200 can also include one or more input devices 208, for example, a keyboard, mouse, trackball, microphone, touch screen, and one or more output devices 210, for example, a printing device, display screen, or speaker. In addition, computer system 200 may contain one or more interfaces (not shown) that can connect computer system 200 to a communication network (in addition or as an alternative to the network that may be formed by one or more of the components of system 200).

According to one or more embodiments of the invention, the one or more input devices 208 may include sensors for measuring parameters of the incoming and treated water streams such as one or more of sensors 114 and 116, and the one or more output devices 210 may include one or more components, such as metering valves and/or pumps of subsystems 122 and 124. Alternatively, the sensors, the metering valves and/or pumps, or all of these components may be connected to a communication network that is operatively coupled to computer system 200. For example, sensors 114 and 116 may be configured as input devices that are directly connected to computer system 200, metering valves and/or pumps of subsystems 122 and 124 may be configured as output devices that are connected to computer system 200, and any one or more of the above may be coupled to another computer system or component so as to communicate with computer system 200 over a communication network. Such a configuration permits one sensor to be located at a significant distance from another sensor or allow any sensor to be located at a significant distance from any subsystem and/or the controller, while still providing data therebetween.

As exemplarily shown in FIG. 3, controller 200 can include one or more computer storage media such as readable and/or writeable nonvolatile recording medium 302 in which signals can be stored that define a program to be executed by one or more processors 306 (such as processor 202). Medium 302 may, for example, be a disk or flash memory. In typical operation, processor 306 can cause data, such as code that implements one or more embodiments of the invention, to be read from storage medium 302 into a memory 304 that allows for faster access to the information by the one or more processors than does medium 302. Memory 304 is typically a volatile, random access memory such as a dynamic random access memory (DRAM) or static memory (SRAM) or other suitable devices that facilitates information transfer to and from processor 306.

Although computer system 200 is shown by way of example as one type of computer system upon which various aspects of the invention may be practiced, it should be appreciated that the invention is not limited to being implemented in software, or on the computer system as exemplarily shown. Indeed, rather than implemented on, for example, a general purpose computer system, the controller, or components or subsections thereof, may alternatively be implemented as a dedicated system or as a dedicated programmable logic controller (PLC) or in a distributed control system. Further, it should be appreciated that one or more features or aspects of the invention may be implemented in software, hardware or firmware, or any combination thereof. For example, one or more segments of an algorithm executable by controller 118 can be performed in separate computers, which in turn, can be in communication through one or more networks.

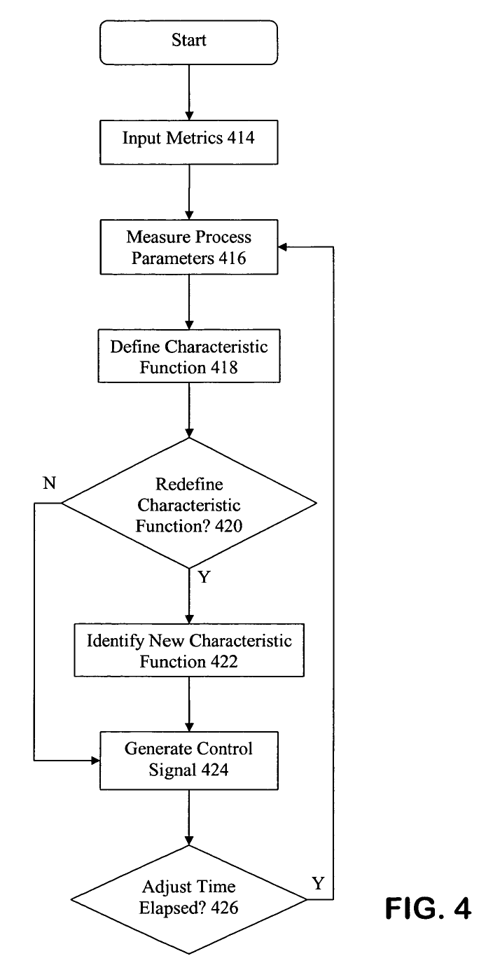

FIG. 4 is an flowchart that exemplarily depicts the operation of one or more systems and techniques according to one or more embodiments of the invention. Although the operation of the system is described primarily with respect to a water treatment method or routine that may be executed by a controller (e.g., controller 118 of FIG. 1 exemplarily configured as computer system 200 of FIG. 2), it should be appreciated that the invention is not so limited, and many of the steps described below may be implemented manually, by a person, for example, rather than by one or more electronic, mechanical or electromechanical devices, as discussed in more detail further below. Further other systems and techniques of the invention can be implemented to facilitate treatment or control of addition of one or more reactant species, effect or control a reaction, regulate activity of one or more subsystems, and/or provide a desired condition of the fluid to be treated, based on one or more characteristic functions.

At step 414, a user is typically requested to input metrics pertaining to a current, desired, and/or acceptable quality of the water. For example, the user may be prompted to enter natural parameters pertaining to the water system such as the water volume and/or concentration of disinfecting species to be added as well as parameters related to a desired water quality such as, but not limited to, maximum and/or minimum allowed values for the pH of the fluid to be treated or a target pH as well as an acceptable range or tolerance by which the pH value may fluctuate, maximum and/or minimum values for the concentration of one or more disinfecting species or proxies thereof or a target concentration of one or more disinfecting species or proxies thereof as well as a tolerance by which such concentrations can rise and fall, and maximum and/or minimum values for the oxidation-reduction potential of the fluid or a target ORP value along with an acceptable tolerance. Where there are applicable mandated municipal, state, federal or other government requirements or guidelines, or where there are safety and/or environmental requirements or guidelines, such values may likewise be entered. It should be appreciated that other parameters may be entered at step 414 such as, but not limited to, the estimated flow rate of a stream comprised of the water to be treated or make up water, as the invention is not limited to a particular set of metrics. Moreover, physical parameters that may impact treatment, such as a tolerable delay or smoothing time may likewise be entered.

At step 416, the treatment routine can measure various parameters of the water as, for example, determined by one or more of the plurality of sensors 114 and 116. Parameters that may be measured at step 416 may include, but are not limited to, the temperature of the water, the oxidation-reduction potential of the water, the pH of the water, the concentration of a disinfecting species in the water, the concentration of free available chlorine species in the water, or any combination of these parameters. Other parameters that may be measured at step 416 may include, for example, operational information such as flow rate, fluid level, and, in some cases, one or more surrogates or proxies for one or more properties of the water. One or more of the measured parameters of the water system may be temporarily stored in memory 204 of the controller (e.g., RAM), and/or stored in a less volatile form of memory of the controller 118, for example, storage system 212 or 302, to use as historical data which may be utilized to effect various operations of the controller, as discussed more fully below. In some cases, one or more of the measured parameters can be directed to one or more output devices 210, which can, for example, print and/or transmit the one or more measured values to one or more locally and/or remotely located systems, facilities, and/or stations. For example, output device 210 can comprise a communication device, such as a transmitter, that can effect a wired or wireless link or connection so that the value of one or more measured parameters, which can be raw, analyzed, or normalized, can be received or collected by one or more corresponding receiving devices.

After acquiring parameters of the incoming stream, the routine typically proceeds to step 418, wherein the routine can determine, identify, and/or define a characteristic function based on one or more of the measured parameters. Typically, during startup or initial/default conditions, the controller operates under a default control function and the inputting metrics 414 and/or measuring process parameters 416 may be omitted when appropriate. The default control function can be utilized to generate one or more control signals 126 that can be utilized to actuate of one or more components, such as valves and pumps, in one or more subsystems 122 and 124 to regulate activity of one or more disinfecting systems and in some cases facilitate pH control. Further, the controller can be utilized to calibrate components or subsystems of the water systems during startup or initial/default conditions.

At steps 418 and 420, the existing or current characteristic function is verified to assess whether a change is appropriate. Characteristic function verification can be performed by comparing one or more measured parameters to its corresponding calculated or expected value. For example, a set of measured parameters, acquired at step 416, such as the concentration of free available chlorine species in the water with a coincidental oxidation-reduction potential value can have a corresponding, expected oxidation-reduction potential value calculable from a current DCRR. Calculation of the expected ORP value can be effected by performing an operation, defined by a function delineating the characteristic relationship, on an operand, such as FAC value.

In particular, at step 420, the routine can determine whether a change in the characteristic function is appropriate. Redefining or verifying whether the current characteristic function remains valid depends on recognizing whether the current characteristic function no longer sufficiently characterizes the chemical processes or relevant conditions in the water. For example, the characteristic function can comprise a particular dynamic chlorine redox relationship. Thus, at step 420 the routine assesses whether the current DCRR, e.g. a first DCRR, is valid; if the current DCRR is not considered valid, the routine redefines the control function (420, Y) and proceeds to identify a new, second, or alternate characteristic function 422.

Adding known aliquots or amounts of a known concentration of chlorine to water and recording the resulting ORP measurement and free chlorine measurement can result in a line whose slope can be predicted. This line can be utilized to describe a relationship between such measurements. For example, with reference to FIG. 5, a plot of ORP values against FAC measurements for relatively clean water, with little organic demand typically results in a logarithmic relationship. For relatively highly loaded water, the relationship remains logarithmic albeit typically with a flattened slope. Thus, at a particular instant, a body of water will have an associated ORP/FAC relationship, referred to herein as a dynamic chlorine redox relationship, DCRR. Notably, knowing that the slope of the chlorine redox relationship is predictable enables identification of an infinite number of such characteristic relationships, as long as at least one point of the relationship is known. For example, relatively clean water, substantially free of contaminants, typically has a DCRR factor as low as about 0.8 whereas organically-loaded water can have a high DCRR factor, as high as 10. If the organic content of a body of water varies, adding known aliquots of chlorine will not result in ORP and free chlorine measurements behaving according to one relationship, a new chlorine redox relationship may provide acceptable characterization as the organic loading either increases or decreases. Thus, in accordance with one or more embodiments of the invention, at any point in time, if the free chlorine measurement and the slope of the resulting chlorine redox relationship line can be determined, an ORP value can be calculated and compared to the ORP measurement. If the ORP measurement and the calculated ORP value differ by a predetermined amount, a new chlorine redox relationship can be identified from which to compare future calculated and measured ORP values.

For example, with reference to FIG. 5, if the measured FAC is about 0.5 mg/l, the expected ORP is about 695 mV for DCRR 510. However, if the measured ORP is greater than or less than a tolerance or threshold value, thereby creating a valid triggering condition, then the characteristic function will be redefined (420, Y) and a new control signal is generated 424, e.g., a second control signal, based on a second DCRR 520. Otherwise, no change in the current characteristic function is necessary (420, N) and a new output control signal is generated based on the same, current characteristic function to maintain a target ORP value and/or a target FAC concentration value. Likewise, the characteristic function can be directed to controlling pH. The pH of the water can be adjusted by introducing an amount of one or more acids, bases, and/or buffering species. The amount of pH adjusting species added thereto is expected to produce an expected pH change. However, if the resultant pH or the change in pH fails to respond or behave as predicted, other factors should be considered thereby initiating a triggering condition. If the triggering condition satisfies a threshold requirement, identification of an alternate or second characteristic function is initiated. The identified second characteristic function can then be utilized to generate a second control signal.

Identifying a second characteristic function 422 can be performed by any suitable heuristic technique. For example, curve fitting and/or linear or non-linear regression techniques can be utilized. A set or array of historical, measured ORP and FAC values can be utilized to identify the second characteristic function that provides an acceptable or suitable association between a first measured parameter and a second measured parameter. For example, with reference to FIG. 5, a first characteristic function can be represented by a dashed DCRR curve 510 when a first array of measured parameters including a first set of measured ORP values sufficiently corresponds with a corresponding first set of measured FAC values. A second characteristic function can be represented by the solid DCRR curve 520 when a second array of measured parameters including a second set of measured ORP values sufficiently corresponds with a corresponding second set of measured FAC values. The second characteristic function becomes sufficiently identified when the measured set of parameters is sufficiently characterized by such function to, for example, within an acceptable confidence level. Statistical techniques can be utilized to determine whether there is sufficient characterization. For example, the second array of measured parameters can be represented by a particular second DCRR if a difference between the expected and measured values are within a predetermined confidence limit such as within about a 90% confidence limit, within a 95% limit or even within about a 99% limit. In other cases, sufficient characterization can be defined when a difference between the expected and measured values is within an acceptable, predetermined, or pre-selected tolerance or within an acceptable percentage for one or more corresponding parameters. The predetermined tolerance between the expected and measured ORP can be, for example, within about 3 mV to about 50 mV, less than about 10 mV, and/or, in some cases, within about 0.5% to about 5% of the expected value. Further, the tolerance can vary, as appropriate, to provide acceptable characteristic function determination. For example, because the slope of the DCRR typically decreases at higher FAC values, acceptable tolerances that can initiate one or more triggering conditions or define an acceptable DCRR characteristic function, can be reduced accordingly. Thus, an acceptable deviation between expected and measured ORP, for example, can be less than about 10 mV at lower FAC values, e.g. less than about 1 mg/l, but can also be about 3 mV at higher FAC values, e.g. greater than about 1 mg/l.

Alternatively or in conjunction with the above techniques, a characteristic relationship can be identified based on the corresponding measurements and a slope thereof. For example, as discussed above, DCRR can be defined by the ORP and FAC measurements and validity thereof can be evaluated with respect to an acceptance tolerance. Identification of a more suitable DCRR can be based on the slope of measured parameters.

Thus, in accordance with one or more embodiments of the invention, a plurality of characteristic functions, including or in some cases, in alternative thereto, slopes of characteristic functions can be stored in storage medium 302 or be otherwise accessible to processor 202. However, in some embodiments of the invention, one or more characteristic functions can be generated during use of the aquatic facility and provide a site-specific or tailored control system and can be stored in volatile or, preferably, non-volatile memory of the system.

An output control signal can then be generated 424 based on the active characteristic function. The control signal can then be transmitted to one or more subsystems 122 and 124 to regulate, for example, addition of a species or activity thereof. For example, with reference to FIG. 1, a first component of control signal 126 can be generated and transmitted from controller 118 to subsystem 122 which can be a disinfecting system disposed and configured to introduce one or more disinfecting species, or one or more precursors thereof, such as chlorine, to achieve a target FAC concentration and/or a target ORP in water 112. In accordance with further embodiments of the invention, step 424 can generate a second control signal component of signal 126 to subsystem 124, which can comprise a secondary disinfecting or treatment system. Secondary disinfecting system 124 can comprise a source of actinic radiation and configured to provide, for example, electromagnetic energy to at least a portion of water 112 and initiate one or more reactions therein that can promote, at least partially, conversion, disinfection, and/or deactivation of one or more target species in water 112. For example, system 124 can comprise an ultraviolet radiation source that is configured to be activated by a control signal 126 from controller 118. Control of the actinic radiation source can further employ any one or more techniques typically utilized in control schemes including, for example, on/off, proportional, derivative, integral, or combinations thereof. The ultraviolet radiation source can be regulated to emit electromagnetic radiation at or about 254 nm, the intensity and/or duration of which can be regulated to destroy, promote lysis, and/or inactivate at least a portion of any organic and/or biologically active material in the fluid to be treated.

Optionally, a time-based adjustment or delay step 426 can be further utilized. At time elapsed step 426, the control signal is retained until a predetermined or preset period has passed before transmission thereof to one or more subsystems 122 and 124 or components thereof. Such time delay techniques can be utilized to provide control stability by ensuring that system 100 has reached or is approaching a steady state condition, typically as a result of any action previously performed, before any further action is subsequently executed.

The routine exemplarily shown in FIG. 4 relates to one or more embodiments of the invention. The invention is not limited to the sequence of steps presented. For example, the step of determining whether the adjust time has elapsed can be performed after process parameter measurement step 416 and/or before the control signal generation step 424. Further, a plurality of characteristic functions can be performed in accordance with the invention. Each of the one or more controlling steps described can be performed sequentially or concurrently for each of the plurality of characteristic functions.

Although the invention is not limited to a particular value or range of values of pH, FAC, and/or ORP, the amount of species added is preferably sufficient to at least partially render inactive or inert any target species to disinfect the water. Further, other parameters may be measured and utilized in the systems and techniques of the invention. Thus, for example, a concentration of a proxy species can be measured, for example, in atmosphere exposed to the water, to provide an indication of concentration of the corresponding dissolved species. The systems and techniques of the invention are not limited to particular species or surrogates therefor and can be utilized in systems comprising two or more characteristic functions. Further, other control routines employing, for example, proportional, derivative, and/or integration based techniques can be implemented. Likewise, nested control loops can be utilized or be incorporated in the techniques of the invention. Thus, a target FAC value can be generated according to a characteristic function and be further adjusted to compensate for anticipated changes that can cyclically occur during use of the water system. For example, an aquatic facility can have varying loads associated with increased use. Because such increased loads can have periodic, sometimes well defined cycles, e.g. daily, which typically vary in the morning and/or afternoon, treatment system configurations utilizing the systems and techniques of the invention can be constructed to anticipate such increased and/or decreased loading conditions, fully or even portions thereof.

Where a treatment system such as that illustrated in FIG. 1 is used, the respective amounts of disinfecting species added to the water may be independently adjusted to meet required metrics for the treated water in an economically efficient manner. For example, when it is determined that metrics for the levels of oxidation-reduction potential are met, but appreciable levels of free available chlorine are present, the amount of disinfecting species, or precursors thereof, added may be reduced to further optimize the system. Alternatively, when it is determined that the desired metrics for the levels of, for example, the oxidation-reduction potential are not met, but insufficient free available chlorine is below a desirable range, the amount of the individual or collective disinfecting species added may be increased to further optimize the system.

Adjustment of the individual or collective amounts of the added species, or one or more precursors thereof, may be performed in steps or increments or may be performed utilizing any suitable control algorithm such as but not limited to those employing proportional, integral, and/or derivative based techniques. Other techniques that may be utilized include, for example, on/off control and time-based or adjusted on/off control. Further, the control loops or algorithms may be configured to utilize nesting techniques. The embodiments of treatment systems illustrated in FIG. 1 are exemplarily shown utilizing feedback control. However, feedforward based systems may be utilized in the systems and techniques of the invention.

Although several of the steps or acts described herein have been described in relation to being implemented on a computer system or stored on a computer-readable medium, it should be appreciated that the invention is not so limited. Indeed, any one or more of the steps or acts may be implemented by, for example, an operator, without use of an automated system or computer. For example, the measuring of the parameters of the water may be performed by a human operator, and based upon those parameters, that operator, or another operator may manually adjust amounts of the sulfide-inhibiting species added to the incoming water stream. Accordingly, although the water treatment routine was described primarily with respect to being implemented on a computer, it should be appreciated that the invention is not so limited.

It should be appreciated that numerous alterations, modifications, and improvements may be made to the illustrated treatment system. For example, as discussed above, the parameters of an incoming stream, such as, but not limited to, the flow rate, temperature, pH, can vary in a cyclical manner (e.g., by day of the week, by time of day, etc.). Such historical data reflecting parameters of the water may be used by one or more controllers to predict parameters at a future time, and adjust the amount of added species, the intensity of actinic radiation effectively delivered, and the amount of pH controlling species, in dependence thereon. Moreover, modifications to the algorithm can be incorporated to further enhance the responsiveness of the treatment effect. For example, where a precursor of a disinfecting species is directly introduced, a conversion or equivalent factor can be utilized to provide a correlation of an effective amount of active species delivered.

The various embodiments discussed herein have exemplarily mentioned chlorine, i.e., free available chlorine, as the active and/or disinfecting species, other species, such as other halogen, ozone, and/or peroxygen compounds, can be utilized in accordance with the invention. In some cases, the systems and techniques of the invention can be employed in or as parts of other applications. For example, the systems and techniques of the invention can be utilized where two or more characteristic functions, such as those that pertain to conversion of intermittently present species. Thus, for example, systems that convert a first reactant to a first product can be controlled under a first characteristic function and also be controlled under a second, third, or fourth characteristic function when a second, third, or even a fourth condition exists that affects the conversion, or load, such as the presence or absence of one or more other reactants.

Although various embodiments exemplarily shown have been described as using sensors, it should be appreciated that the invention is not so limited. For example, rather than requiring any electronic or electromechanical sensors, the measurement of levels could alternatively be based upon the senses of an operator. For example, operator-performed colorimetric tests can serve to provide one or more measured parameters. Moreover, the invention contemplates the modification of existing facilities to retrofit one or more systems, subsystems, or components and implement the techniques of the invention. Thus, for example, an existing facility including one or more installed sensors and one or more disinfecting unit operations can be modified to include a controller executing instructions in accordance with one or more embodiments exemplarily discussed herein. Alternatively, existing control systems can be reprogrammed or otherwise modified to perform any one or more acts of the invention. In accordance with one or more embodiments, the invention can provide a method of modifying an existing aquatic facility comprising configuring a controller to execute an algorithm that provides a first control signal based on a first characteristic function and a second control signal based on a second characteristic function, wherein the first characteristic function is defined by a first set of oxidation-reduction potential and free available chlorine concentration measurements of water in the aquatic facility and the second characteristic function is defined by a second set of oxidation-reduction potential and free available chlorine concentration measurements of the water.

### EXAMPLES

The function and advantages of these and other embodiments of the invention can be further understood from the examples below, which illustrate the benefits and/or advantages of the one or more systems and techniques of the invention but do not exemplify the full scope of the invention.

### Example 1

This example describes an algorithm in accordance with one or more embodiments of the invention related to identifying one or more characteristic relationships. In particular, identification of an active DCRR is described.

A millivolt control setpoint along with a millivolt dead band, Xsh, is entered into the controller.

At start up, a chlorine calibration is entered as a temporary chlorine control point. This may be necessary to establish an initial dynamic chlorine redox relationship line. The process algorithm can be set to have a time delay of about two hours prior to performing the first dynamic chlorine relationship line factor calculation. This allows both the ORP and free chlorine sensors to settle after start-up or after a calibration.

After the delay period has expired, the algorithm can verify that the measured pH value is within an acceptable range, about ±0.3 pH units, of the setpoint. Further, the algorithm can verify that the time expired since the last calculation is greater than programmed. This time period between DCCR line factor calculations can be adjustable.

The system can also verify that the measured chlorine value is within about 5% of the chlorine control point, typically to ensure that the chlorine feed equipment is able to keep up with the demand. Further, the system can verify whether the calculated ORP value differs from the measured ORP value by a predetermined amount.

Such a dead band time, described in terms of the millivolt reading, within which the process algorithm performs a DCCR line factor recalculation, is adjustable from about 3 millivolts up to about 50 millivolts. This dead band adjustment can be used to tune how responsive to the process algorithm is to changes in organic loading. Thus, the greater the dead band value, the slower response of the process algorithm in updating the DCCR line factor with respect to changes in organic loading. This dead band time is typically modifiable in terms of the predetermined or modifiable difference between the measured and calculated ORP value.

If all the above-mentioned criteria are met the process algorithm will look up and operate from a new dynamic chlorine redox relationship line factor.

The algorithm will now store and utilize this new DCCR line factor and, if programmed, can be set up to start or stop a secondary disinfection system. The chlorine control point will also change in an attempt to maintain control within the ORP setpoint dead band.

After an adjustable period of the last DCCR line factor calculation has past, the steps can be repeated, although the millivolt setpoint typically not need to be entered again. The adjustable period between DCCR line factor recalculation is adjustable from about one minute to about thirty minutes.

### Example 2

This example describes a system utilizing the techniques of the invention. The system, as substantially represented in the schematic illustration of FIG. 1, was comprised of about a five gallon container of water circulating past a chemical controller. Muriatic acid, about 18% HCl, was used to maintain a substantially constant water pH of about 7.2 units. Liquid chlorine, as about a 12% active sodium hypochlorite, was used as a disinfectant source. Diluted glycine, about 1% solution, was introduced to the water as an organic loading source. The dosing rate of glycine added varied from about 0% to about 20%.

The control system incorporated a DCRR algorithm, as substantially described in Example 1 and exemplarily illustrated in FIG. 4, and executed utilizing a STRANTROL® MG/L5 controller, available from USFilter Corporation, Stranco Products, Bradley, Ill. Delay time varied from about three minutes to about fifteen minutes. Free available chlorine measurements were performed utilizing an AAC4807 amperometric measurement cell, available from Wallace & Tiernan GmbH, Günzburg, Germany. ORP measurements were performed utilizing an U-95691 measurement cell, also available from Wallace & Tiernan GmbH, Günzburg, Germany.

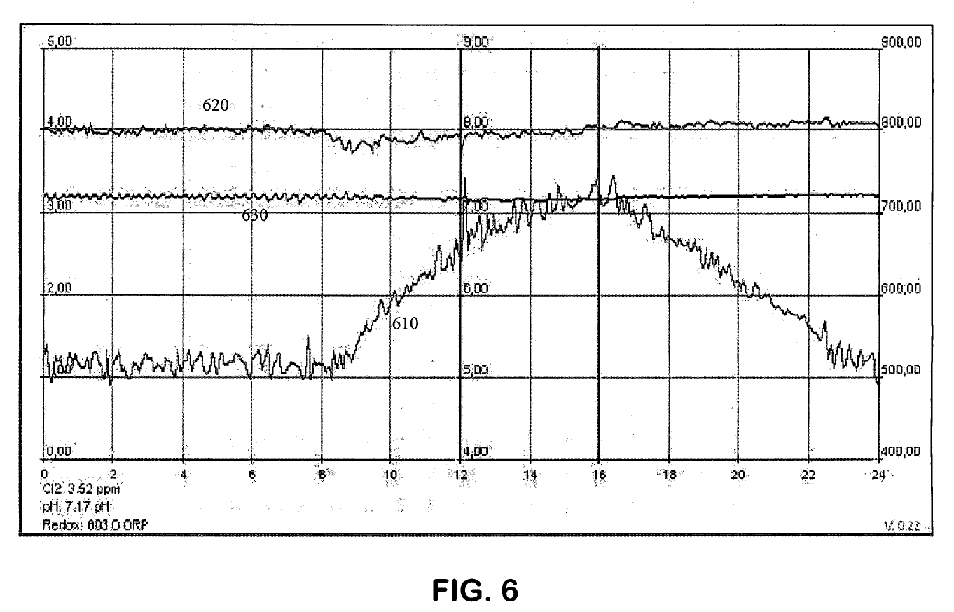

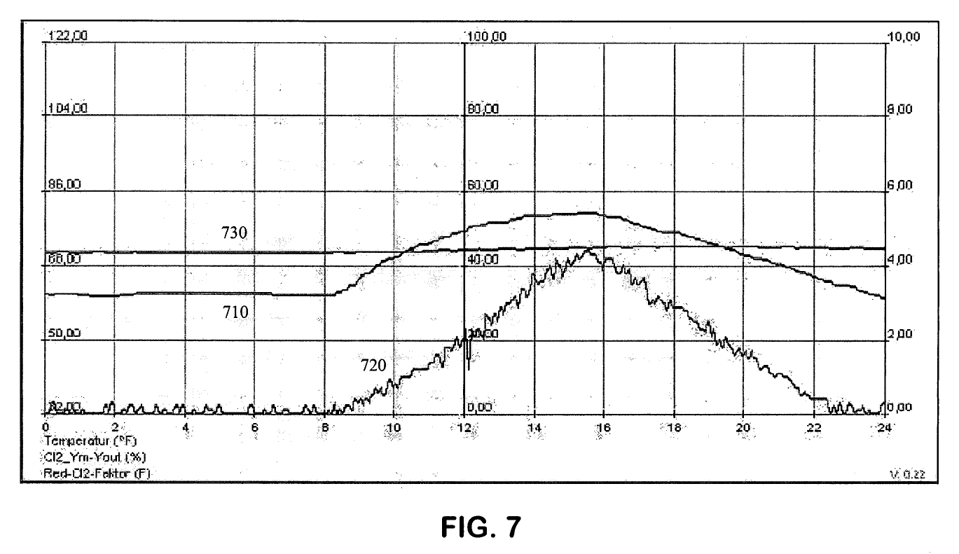

Process data measurements were recorded and graphically presented in FIGS. 6 and 7. The organic loading was increased by the continuous addition of glycine from about the eight hour to the about the 15 hour (abscissa). As shown in FIG. 6, the free chlorine residual measurement 610 increased between about hour 8 and about hour 15. Initially the measured ORP value 620 dropped, as expected because of the increased organic loading.

A calculated DCCR line factor 710 (the slope of ORP relative to FAC) increased as shown in FIG. 7. Likewise, the output signal 720 to the disinfection equipment, which comprised of chlorine feeder, correspondingly increased.

The water pH measurement 630 is also shown in FIG. 6 and the water temperature 730 is shown in FIG. 7. In FIG. 6, three ordinate axes are shown wherein the left ordinate axis corresponds to the measured free available chlorine concentration (ppm), the middle ordinate axis corresponds to the measured pH, and the right ordinate axis corresponds to the measured ORP value (mV). In FIG. 7, three ordinate axes are also shown wherein the left ordinate axis corresponds to the measured temperature (° F.), the middle ordinate axis corresponds to the chlorine output signal (% of full range), and the right ordinate axis corresponds to the calculated DCRR.

After the glycine feed was stopped, the free chlorine measurement decreased in response to a reduced requirement for maintaining the chlorine control point. Meanwhile the DCCR line factor eventually decreased to its original setting of about 3.2.

In response to an increase in organic loading, the DCCR factor increased because of an increase in organic loading. The chlorine control point increased to maintain the ORP setpoint of about 800 millivolts. The output signal to the chlorine feeder increased in response to a decrease in organic loading. Also, the DCCR line factor decreased because of a decrease in organic loading. Notably, the chlorine control point was lowered to maintain the ORP setpoint of about 800 millivolts

This system did not include the use of a secondary disinfection system to help with the breakdown of the organic loading but relied solely on the oxidation process of chlorine. However, the addition of a secondary oxidation system, such as one including an ultraviolet radiation source emitting at about 254 nm, could have been employed whilst the DCCR line factor was above 4.0, thereby effectively operating the secondary disinfection system during the period of high organic loading. The ultraviolet radiation-based secondary disinfection system, in turn, would reduce the chlorine feed requirement and, for a nitrogen based organic compounds, would reduce the accumulation of chloramines.

### Example 3

A pool test using the process algorithm was performed in an aquatic facility in Ichenhausen, Germany. The chemical treatment of this about 50,000 gallon pool was comprised of two vertical pressure sand filters and utilized pH adjustment, to about 7.2 units, by controlling addition of muriatic acid (about 18% HCl). Calcium hypochlorite (65% as active chlorine), from Silbermann, Chemie & Technik, Gablingen, Germany, was used to provide the disinfecting species. Fresh water was used as fill to maintain a DIN (German Institute for Standardization) mandated standard of about eight gallons per bather per day. The ORP target ranged from about 650 mV to about 850 mV. The target free available chlorine concentration was ranged from about 0 to about 10 mg/l.

The control system incorporated a DCRR algorithm, as substantially described above and exemplarily illustrated in FIG. 4, executed utilizing a STRANTROL® MG/L5 controller, available from USFilter Corporation, Stranco Products, Bradley, Ill. Delay time varied from about three minutes to about fifteen minutes. Free available chlorine measurements were performed utilizing an AAC4807 amperometric measurement cell, available from Wallace & Tiernan GmbH, Günzburg, Germany. ORP measurements were performed utilizing an U-95691 measurement cell, also available from Wallace & Tiernan GmbH, Günzburg, Germany.

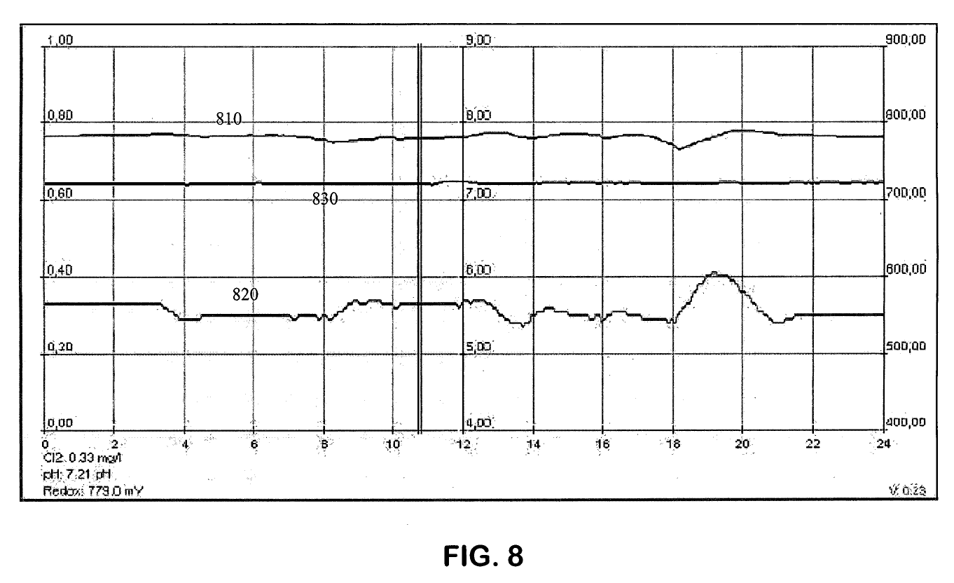

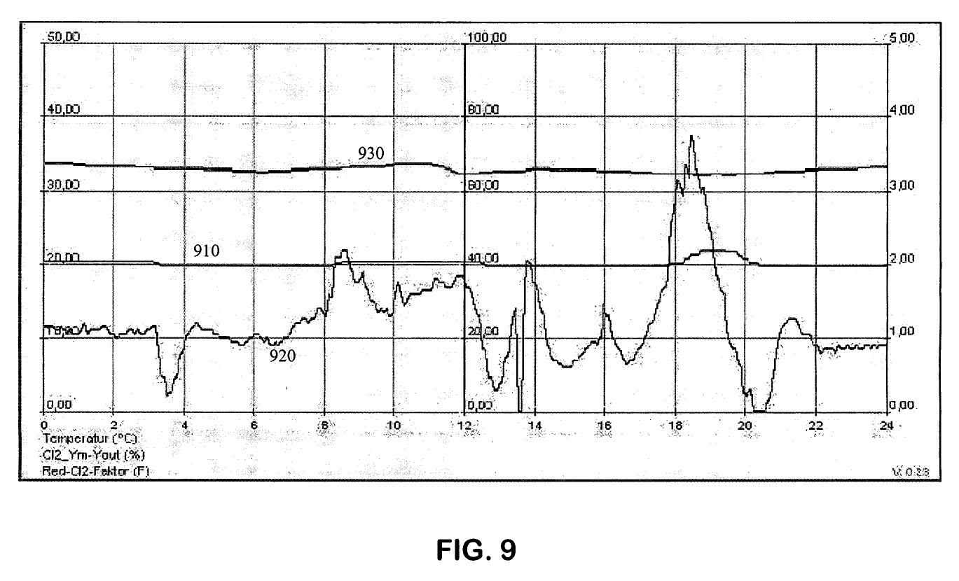

As shown in FIGS. 8 and 9, an increase in organic loading (bathers entering the pool) was noted at approximately the 18^{th} hour (abscissa). Initially the chlorine control point did not sufficiently maintain the desired ORP setpoint as shown by the declining ORP measurement 810 at about the 17 hour point. The DCCR factor 910 was thereafter recalculated. This resulted in an increased DCCR line factor, and also resulted in an increase of the chlorine output control signal 920 based on the recalculated DCRR. The DCCR line factor decreased after the organic loading declined at after about the 19^{th} hour. The pH 830 and temperature 930 values were also monitored. This example showed that a system incorporating the systems and techniques of the invention was capable of controlling addition of a disinfecting species based on a one or more characteristic functions.

In FIG. 8, three ordinate axes are shown wherein the left ordinate axis corresponds to the measured free available chlorine concentration (mg/l), the middle ordinate axis corresponds to the measured pH, and the right ordinate axis corresponds to the measured ORP value (mV). In FIG. 9, three ordinate axes are also shown wherein the left ordinate axis corresponds to the measured temperature (° C.), the middle ordinate axis corresponds to the chlorine output signal (% of full range), and the right ordinate axis corresponds to the calculated DCRR.

Having now described some illustrative embodiments of the invention, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. For example, the invention may utilize a single processor to control treatment operations of a plurality facilities. Thus, controller 118 may be operably linked to a first aqueous facility comprising a first body of water 112 to be treated and a second body of water (not shown) adjacent thereto in the same facility or a facility remotely displaced from the first aqueous facility. Communication of signal therebetween can be effected through any suitable conduit including, for example, through radio telecommunications systems or through the Internet. Further, acts, elements, and features discussed only in connection with one embodiment are not intended to be excluded from a similar role in other embodiments. It is to be appreciated that various alterations, modifications, and improvements can readily occur to those skilled in the art and that such alterations, modifications, and improvements are intended to be part of the disclosure and within the spirit and scope of the invention. For example, the invention contemplates the use of various wired or wireless protocols to effect communication between systems, subsystems, and/or components thereof. Moreover, it should also be appreciated that the invention is directed to each feature, system, subsystem, or technique described herein and any combination of two or more features, systems, subsystems, or techniques described herein and any combination of two or more features, systems, subsystems, and/or methods, if such features, systems, subsystems, and techniques are not mutually inconsistent, is considered to be within the scope of the invention as embodied in the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Those skilled in the art should appreciate that the parameters and configurations described herein are exemplary and that actual parameters and/or configurations will depend on the specific application in which the systems and techniques of the invention are used. Those skilled in the art should also recognize or be able to ascertain, using no more than routine experimentation, equivalents to the specific embodiments of the invention. It is therefore to be understood that the embodiments described herein are presented by way of example only and that, within the scope of the appended claims and equivalents thereto; the invention may be practiced otherwise than as specifically described.

What is claimed is:

1. A method of facilitating water quality characterization comprising an act of providing a controller configured to receive a plurality of measurement signals from at least one oxidation-reduction potential sensor and at least one free available chlorine sensor, to generate a first control signal based at least in part on a first dynamic chlorine redox relationship, and to generate a second control signal based at least in part on a second dynamic chlorine redox relationship.

2. A method of facilitating water treatment comprising acts of:
mapping a first set of corresponding oxidation-reduction potential and free available chlorine values of the water to define a first control function;
generating a first control signal based on the first control function;
mapping a second set of corresponding oxidation-reduction potential and free available chlorine values of the water to define a second control function; and
generating a second control signal based on the second control function.

3. A method of treating water comprising acts of:
generating a first control signal according to a first control function;
generating a second control signal according to a second control function; and
regulating operation of a primary disinfecting system fluidly connected to the water based on the first control signal;
wherein the first control function is mapped at least in part by a first set of measured process parameters of the water and the second control function is mapped at least in part by a second set of measured process parameters.

4. The method of claim 3, wherein the first set of measured process parameters comprises a first array of corresponding measured oxidation-reduction potential values and free available chlorine species concentration values of the water.

5. The method of claim 4, wherein the second set of measured process parameters comprises a second array of corresponding measured oxidation-reduction potential values and free available chlorine species concentration values of the water.

6. The method of claim 5, wherein the second array of corresponding measured oxidation-reduction potential values and free available chlorine species concentration is measured after a predetermined time following measurement of the first array of corresponding measured oxidation-reduction potential values and free available chlorine species concentration values.

7. The method of claim 3, further comprising an act of identifying a triggering condition before performing the act of generating the second control signal.

8. The method of claim 3, wherein the act of generating the second control signal is performed if a threshold requirement is satisfied.

9. The method of claim 3, wherein the second control signal regulates operation of a secondary disinfecting system fluidly connected to the water.

10. The method of claim 9, wherein the secondary disinfecting system comprises an actinic radiation apparatus.

11. A computer-readable medium including computer-readable signals stored thereon defining instructions that, as a result of being executed by a computer, instruct the computer to perform a method of facilitating water treatment comprising acts of:
generating a first control signal according to a first control function; and
generating a second control signal according to a second control function;
wherein the first control function is mapped at least in part by a first set of measured process parameters of the water and the second control function is mapped at least in part by a second set of measured process parameters.

12. A method of treating water comprising acts of:
measuring a first oxidation-reduction potential and a first concentration of free available chlorine species of the water;
identifying a first control profile based at least in part on the first measured oxidation-reduction potential and the first measured free available chlorine species concentration;
regulating addition of a source of free available chlorine species into the water based on the first control profile;
measuring a second oxidation-reduction potential and a second concentration of free available chlorine species of the water; and
identifying a second control profile based on at least one of the second measured oxidation-reduction potential and the second measured free available chlorine species concentration.

13. The method of claim 12, wherein the first control profile defines a first dynamic chlorine redox relationship.

14. The method of claim 13, wherein the second control profile defines a second dynamic chlorine redox relationship.

15. The method of claim 12, further comprising an act of generating a control signal based on the second control profile.

16. The method of claim 15, further comprising an act of regulating activity of an actinic radiation source based on the second control signal.

17. The method of claim 15, further comprising an act of regulating addition of an oxidizing compound or precursor thereof based on the second control signal.

18. The method of claim 12, further comprising an act of calculating an expected oxidation-reduction potential based on the first control profile.

19. The method of claim 18, further comprising an act of determining a difference between the expected oxidation-reduction potential and the second measured oxidation-reduction potential.

20. The method of claim 19, further comprising an act of comparing the difference between the expected oxidation-reduction potential and the second measured oxidation-reduction potential to a threshold parameter.

21. The method of claim 20, wherein the threshold parameter is about 10 mV.

22. The method of claim 20, wherein the act of identifying the second control profile is performed if the difference between the expected oxidation-reduction potential and the second measured oxidation-reduction potential is greater than the threshold parameter.

23. The method of claim 22, wherein the threshold parameter is in a range from about 3 mV to about 50 mV.

24. The method of claim 12, further comprising an act of regulating a pH of the water to within a predetermined pH range.

25. A system for treating water comprising:
an oxidation-reduction potential sensor disposed in the water and configured to generate an ORP signal corresponding to a measured oxidation-reduction potential of the water;
a free available chlorine species sensor disposed in the water and configured to generate a FAC signal corresponding to a measured concentration of free available chlorine species in the water;
a processor disposed to receive the ORP and FAC signals; and
a storage medium in communication with the processor, the storage medium storing a first dynamic chlorine redox relationship and a second dynamic chlorine redox relationship, wherein the first and second dynamic chlorine redox relationships are defined, at least in part, by corresponding oxidation-reduction potential and free available chlorine species concentration values.

26. The system of claim 25, wherein the processor is configured to generate a first control signal and a second control signal.

27. The system of claim 26, wherein the first control signal is generated based on the first dynamic chlorine redox relationship and the second control signal is generated based on the second dynamic chlorine redox relationship.

28. The system of claim 27, further comprising a pH sensor disposed to measure a pH value of the water.

29. A system for treating water comprising:
a first sensor disposed to measure a first process parameter of the water, the first sensor is configured to provide a first measurement signal corresponding to the first process parameter;
a second sensor disposed to measure a second process parameter of the water, the second sensor is configured to provide a second measurement signal corresponding to the second process parameter;
a controller configured to receive the first and second measurement signals and generate a first control signal and a second control signal, the first control signal is based at least in part on a first control relationship between the first measured parameter and the second measured parameter and the second control signal is based at least in part on a second control relationship between the first measured parameter and the second measured parameter; and a primary disinfecting system disposed to receive the first control signal.

30. The system of claim 29, wherein the first process parameter corresponds to an oxidation-reduction potential of the water.

31. The system of claim 30, wherein the second process parameter corresponds to a concentration of free available chlorine species in the water.

32. The system of claim 31, wherein the first control signal is further based on a pH value of the water.

33. The system of claim 31, wherein the primary disinfecting system is configured to introduce a disinfecting species or a precursor thereof to the water based on the first control signal

34. The system of claim 33, further comprising a secondary disinfecting system comprising an actinic radiation source, the secondary disinfecting system is configured to irradiate at least a portion of the water based on the second control signal.

35. The system of claim 31, further comprising a secondary disinfecting system comprising a source of a second disinfecting species, the secondary disinfecting system is disposed to introduce an amount of the second disinfecting species or a precursor thereof according to the second control signal.

36. The system of claim 29, wherein the controller is configured to generate a third control signal that is based at least in part on a third control relationship between the first measured parameter and the second measured parameter.

37-46. (canceled)
